(19) United States
(12) Patent Application Publication
(10) Pub. No.: US 2025/0381848 A1
(43) Pub. Date: Dec. 18, 2025

(54) MOUNTING STRUCTURE FOR VEHICLE COMMUNICATION DEVICE

(71) Applicant: TOYOTA JIDOSHA KABUSHIKI KAISHA, Toyota-shi (JP)

(72) Inventor: Gou SHIMURA, Toyota-shi (JP)

(73) Assignee: TOYOTA JIDOSHA KABUSHIKI KAISHA, Toyota-shi (JP)

(21) Appl. No.: 19/037,307

(22) Filed: Jan. 27, 2025

(30) Foreign Application Priority Data
Jun. 13, 2024 (JP) 2024-095980

(51) Int. Cl. B60K 35/50; B60H 1/00

(52) U.S. Cl. CPC B60K 35/50; B60H 1/00564; B60K 2360/658

(57) ABSTRACT

A mounting structure for a vehicle communication device includes an instrument panel, a vehicle communication device, and an air conditioning duct. The vehicle communication device is disposed inside the instrument panel and mounted on the instrument panel. The air conditioning duct is part of a vehicle air conditioner and includes a connection portion connected to the vehicle communication device. A portion of the air conditioning duct different from the connection portion is fixed to, and supported by, the instrument panel.

### CROSS-REFERENCE TO RELATED APPLICATION

This application claims priority to Japanese Patent Application No. 2024-095980 filed on Jun. 13, 2024, incorporated herein by reference in its entirety.

### BACKGROUND

### 1. Technical Field

The present disclosure relates to mounting structures for vehicle communication devices.

### 2. Description of Related Art

Japanese Unexamined Patent Application Publication No. 2022-157528 (JP 2022-157528 A) discloses a vehicle communication device disposed on the inner side of an instrument panel. A housing of the vehicle communication device described in JP 2022-157528 A is provided with a flange. The vehicle communication device is mounted on the instrument panel by fixing the flange to the instrument panel via a fixing member.

### SUMMARY

In a configuration in which a vehicle communication device is mounted on an instrument panel, a load is applied to a portion of the instrument panel on which the vehicle communication device is mounted due to vibration caused by traveling of a vehicle.

In view of the above, it is an object of the present disclosure to provide a mounting structure for a vehicle communication device that can reduce a load that is applied to a portion of an instrument panel on which a vehicle communication device is mounted.

A mounting structure for a vehicle communication device of a first aspect includes:
an instrument panel;
a vehicle communication device disposed inside the instrument panel and mounted on the instrument panel; and
an air conditioning duct that is part of a vehicle air conditioner, the air conditioning duct including a connection portion to which the vehicle communication device is connectable, and a portion of the air conditioning duct different from the connection portion being fixed to, and supported by, the instrument panel.

In the mounting structure of the first aspect, the vehicle communication device is disposed inside the instrument panel and mounted on the instrument panel. The vehicle communication device mounted on the instrument panel is connected to the connection portion of the air conditioning duct. The portion of the air conditioning duct different from the connection portion is fixed to, and supported by, the instrument panel. In this configuration, the air conditioning duct functions as a dynamic damper. It is therefore possible to reduce vibration that occurs in an up-down direction in the vehicle communication device and the portion of the instrument panel on which the vehicle communication device is mounted. As a result, it is possible to reduce a load that is applied to the portion of the instrument panel on which the vehicle communication device is mounted in response to a road surface input to a vehicle.

According to a mounting structure for a vehicle communication device of a second aspect, in the mounting structure of the first aspect, an elastically deformable elastic member may be interposed between the vehicle communication device and the connection portion.

In the mounting structure of the second aspect, the elastically deformable elastic member is interposed between the vehicle communication device and the connection portion of the air conditioning duct. In this configuration, the elastic member can absorb vibration that occurs in the up-down direction in the portion of the instrument panel on which the vehicle communication device is mounted in response to the road surface input to the vehicle.

According to a mounting structure for a vehicle communication device of a third aspect, in the mounting structure of the second aspect, a spring constant of the elastic member may be set in such a manner that a resonance frequency of the instrument panel and the vehicle communication device in response to a road surface input to a vehicle coincides with a resonance frequency of the air conditioning duct in response to the road surface input to the vehicle.

The mounting structure of the third aspect can further reduce vibration that occurs in the up-down direction in the vehicle communication device and the portion of the instrument panel on which the vehicle communication device is mounted in response to the road surface input to the vehicle, compared to a configuration in which the spring constant of the elastic member is set outside the above range.

According to a mounting structure for a vehicle communication device of a fourth aspect, in the mounting structure of the second or third aspect, a value of change in an elastic modulus per unit temperature change of a material of the instrument panel may coincide with a value of change in an elastic modulus per unit temperature change of a material of the elastic member.

In the mounting structure of the fourth aspect, stiffness of the elastic member changes corresponding to a change in stiffness caused by a temperature change of the instrument panel. It is therefore possible to maintain the function of the air conditioning duct as a dynamic damper even when the temperature of the instrument panel and the elastic member changes.

The mounting structure for the vehicle communication device according to the present disclosure is highly advantageous in that it can reduce a load that is applied to the portion of the instrument panel on which the vehicle communication device is mounted.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a left side sectional view schematically showing a portion of an instrument panel on which a vehicle communication device is mounted;

FIG. 2 is a bottom view schematically illustrating a front end of an air conditioning duct and a vehicle communication device;

FIG. 3 is a sectional view of the connection portion and the like taken along III-III shown in FIG. 2;

FIG. 4 is a graph showing the relationship between the elastic modulus of resin and the temperature; and

FIG. 5 is a graph showing the relationship between the elastic modulus of rubber and the temperature.

### DETAILED DESCRIPTION OF EMBODIMENTS

Hereinafter, a front portion of the cabin 10 to which the mounting structure of the vehicle communication device according to the embodiment of the present disclosure is applied will be described with reference to the drawings. Note that the arrow FR appropriately shown in the drawings indicates the vehicle front side, the arrow UP indicates the vehicle upper side, the arrow LH indicates the left side in the vehicle width direction (left-right direction), and the arrow RH indicates the right side in the vehicle width direction (left-right direction). In the following description, the directions indicating forward, rearward, upward, downward, and leftward, and rightward indicate forward and rearward in the vehicle front-rear direction, upward and downward in the vehicle up-down direction, and leftward and rightward in the vehicle left-right direction unless otherwise specified.

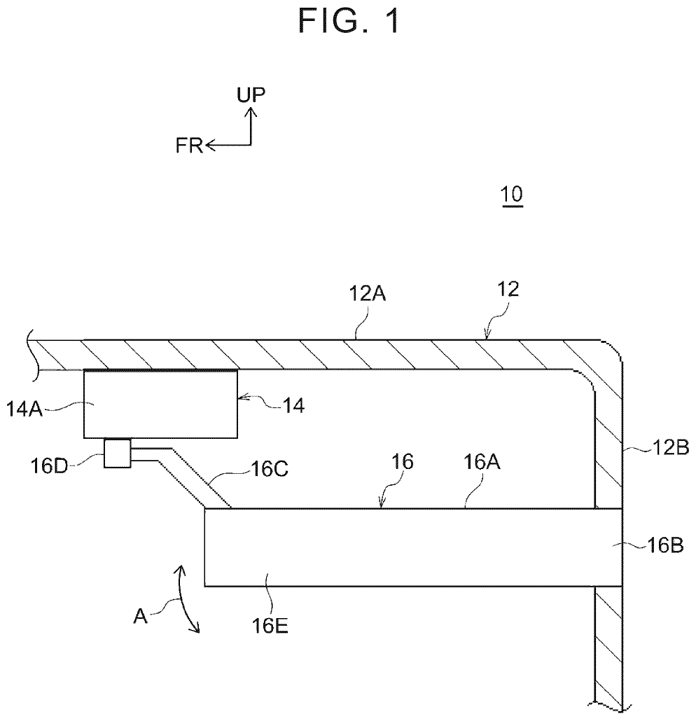

As illustrated in FIG. 1, an instrument panel 12, a vehicle communication device 14 provided in the instrument panel 12, and an air conditioning duct 16 provided in the instrument panel 12 are provided at a front portion of the cabin 10.

The instrument panel 12 (instrument panel safety pad) is formed using a resin material as an example. The instrument panel 12 includes a first extending portion 12A extending in the front-rear direction and the left-right direction, and a second extending portion 12B extending downward from the rear end of the first extending portion 12A.

The vehicle communication device 14 is referred to as a DCM (Data Communication Module), and is a device for wirelessly communicating with another device or an external network through a network. The housing 14A of the vehicle communication device 14 is provided with a locking portion (not shown). Then, the locking portion is locked to a locked portion (not shown) provided on the instrument panel 12, for example, so that the vehicle communication device 14 is mounted on the first extending portion 12A of the instrument panel 12.

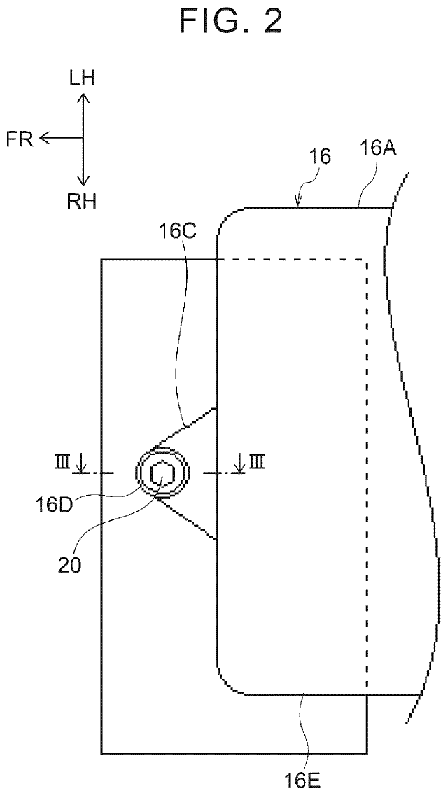

The air conditioning duct 16 is part of a vehicle air conditioner, and is formed using a resin material as an example. The air conditioning duct 16 includes a duct body portion 16A through which air passes. The rear end 16B of the duct body portion 16A is provided with an air outlet through which air is blown toward the cabin 10. Further, the rear end 16B of the duct body portion 16A, a register for adjusting the wind direction is provided. Here, the rear end 16B of the duct body portion 16A is fixed to, and supported by, the second extending portion 12B of the instrument panel 12. Accordingly, the air conditioning duct 16 is supported by the instrument panel 12 in a cantilevered manner. As shown in FIGS. 1 and 2, the air conditioning duct 16 includes a front extending portion 16C extending upward and forward from a front end of the duct body portion 16A. The front end of the front extending portion 16C is a connection portion 16D connected to the vehicle communication device 14.

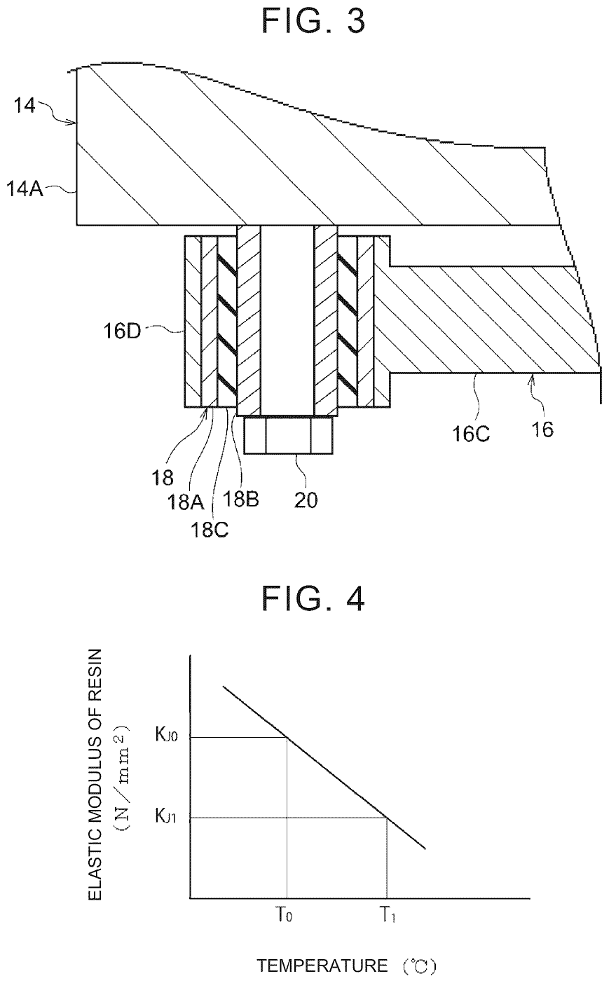

As shown in FIG. 3, a bushing 18 is fixed to the connection portion 16D. The bushing 18 includes an outer tubular portion 18A, an inner tubular portion 18B, and an clastic member 18C. The outer tubular portion 18A is formed in a tubular shape. The inner tubular portion 18B is formed in a tubular shape and is disposed in the central portion of the outer tubular portion 18A. The elastic member 18C connects the outer tubular portion 18A and the inner tubular portion 18B. The elastic member 18C is formed by using a rubber that can be elastically deformed. The bolt 20 inserted into the inner tubular portion 18B is screwed into the housing 14A of the vehicle communication device 14, whereby the connection portion 16D and the vehicle communication device 14 are connected via the bushing 18 and the bolt 20.

### Functions and Effects of Embodiment

Next, functions and effects of the present embodiment will be described.

As shown in FIG. 1, in the present embodiment described above, the connection portion 16D of the air conditioning duct 16 is connected to the vehicle communication device 14, and the air conditioning duct 16 is supported by the instrument panel 12 in a cantilevered manner. In this configuration, the front-side portion 16E of the air conditioning duct 16 can be displaced in the up-down direction (vibrate in the direction of arrow A) with respect to a fixed part of the air conditioning duct 16 to the instrument panel 12 as a rotational center. Thus, since the air conditioning duct 16 functions as a dynamic damper, it is possible to reduce the vibration that occurs in the up-down direction in the vehicle communication device 14 and the portion of the instrument panel 12 on which the vehicle communication device 14 is mounted. As a result, it is possible to reduce the load that is applied to the portion of the instrument panel 12 on which the vehicle communication device 14 is mounted in response to the road surface input to the vehicle.

Further, as shown in FIG. 3, in the present embodiment, a bushing 18 is interposed between the vehicle communication device 14 and the connection portion 16D of the air conditioning duct 16. In this configuration, the elastic member 18C can absorb the vibration that occurs in the up-down direction in the vehicle communication device 14 and the portion of the instrument panel 12 on which the vehicle communication device 14 is mounted in response to the road surface input to the vehicle.

Here, the spring constant of the elastic member 18C may be set so that the resonance frequency of the instrument panel 12 and the vehicle communication device 14 in response to the road surface input to the vehicle coincides with the resonance frequency of the air conditioning duct 16 in response to the road surface input to the vehicle. This configuration can further reduce the vibration that occurs in the up-down direction in the vehicle communication device 14 and the portion of the instrument panel 12 on which the vehicle communication device 14 is mounted in response to the road surface input to the vehicle, compared to a configuration in which the spring constant of the elastic member 18C is set outside the above range.

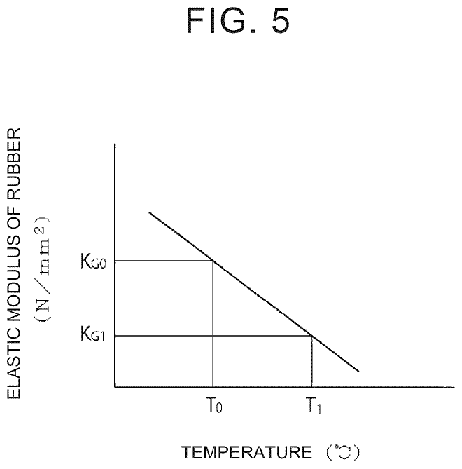

Incidentally, when the temperature of the instrument panel 12 increases with the incidence of sunlight into the cabin 10 or the like, the elastic modulus (stiffness) of the instrument panel 12 decreases. Similarly, when the elastic member 18C is heated, the clastic modulus (stiffness) of the elastic member 18C decreases. For example, as shown in FIG. 4, when the temperature of the resin forming the instrument panel 12 increases from T₀ (C) to T₁ (° C.), the clastic modulus of the resin decreases from K_{J0} (N/mm²) to K_{J1} (N/mm²). Further, as shown in FIG. 5, when the temperature of the rubber forming the elastic member 18C increases from T₀ (C) to T₁ (C), the elastic modulus of the rubber decreases from K_{G0} (N/mm²) to K_{G1} (N/mm²). The decrease in the elastic modulus results in a decrease in the resonance frequency of the instrument panel 12 and the vehicle communication device 14, and a decrease in the resonance frequency of the air conditioning duct 16. Therefore, the material of the instrument panel 12 and the material of the elastic member 18C may be selected and adjusted so that a value of change in elastic modulus per unit temperature change of the material of the instrument panel 12 coincides with a value of change in elastic modulus per unit temperature change of the material of the elastic member 18C, that is, the relation of K_{J1}/K_{J0}=K_{G1}/K_{G0} is satisfied. In the configuration satisfying the above relationship, stiffness of the elastic member 18C changes corresponding to a change in stiffness of the instrument panel 12. As a result, even if the instrument panel 12 and the elastic member 18C change in temperature, it is possible to maintain the function of the air conditioning duct 16 as a dynamic damper.

In the above example, an example in which the bushing 18 is interposed between the vehicle communication device 14 and the connection portion 16D of the air conditioning duct 16 has been described, but the present disclosure is not limited thereto. For example, a configuration in which the bushing 18 is not provided may be employed. Further, the bushing 18 may be a separate component from the air conditioning duct 16, or may be formed integrally with the air conditioning duct 16.

Further, in the present embodiment, an example has been described in which the air conditioning duct 16 is supported by the instrument panel 12 in a cantilevered manner, but the present disclosure is not limited thereto. For example, the air conditioning duct 16 may be supported by a member different from the instrument panel 12 in a cantilevered manner.

Although an embodiment of the present disclosure has been described above, the present disclosure is not limited to the above, and it is needless to say that the present disclosure can be implemented with various modifications other than the above without departing from the gist thereof.

What is claimed is:

1. A mounting structure for a vehicle communication device, the mounting structure comprising:
an instrument panel;
a vehicle communication device disposed inside the instrument panel and mounted on the instrument panel; and
an air conditioning duct that is part of a vehicle air conditioner, the air conditioning duct including a connection portion to which the vehicle communication device is connectable, and a portion of the air conditioning duct different from the connection portion being fixed to, and supported by, the instrument panel.

2. The mounting structure according to claim 1, wherein an elastically deformable elastic member is interposed between the vehicle communication device and the connection portion.

3. The mounting structure according to claim 2, wherein a spring constant of the elastic member is set in such a manner that a resonance frequency of the instrument panel and the vehicle communication device in response to a road surface input to a vehicle coincides with a resonance frequency of the air conditioning duct in response to the road surface input to the vehicle.

4. The mounting structure according to claim 2, wherein a value of change in an elastic modulus per unit temperature change of a material of the instrument panel coincides with a value of change in an elastic modulus per unit temperature change of a material of the elastic member.
